(19) United States
(12) Patent Application Publication
(10) Pub. No.: US 2013/0328339 A1
(43) Pub. Date: Dec. 12, 2013

(54) VEHICLE OUTER MIRROR DEVICE

(71) Applicants: CBC Co., Ltd., Tokyo (JP); KABUSHIKI KAISHA TOKAI-RIKA-DENKI-SEISAKUSHO, Aichi-ken (JP)

(72) Inventors: Takehiro HAMADA, Aichi-ken (JP); Masakazu IWATSUKI, Aichi-ken (JP); Koichi HARUTA, Mishima city (JP); Takafumi SAITO, Mishima city (JP); Kengo OKAMOTO, Mishima city (JP); Shinobu CHIBA, Mishima city (JP)

(21) Appl. No.: 13/913,662

(22) Filed: Jun. 10, 2013

(30) Foreign Application Priority Data
Jun. 12, 2012 (JP) 2012-133081

(51) Int. Cl. B60R 1/06

(52) U.S. Cl. CPC B60R 1/06
USPC 296/1.11

(57) ABSTRACT

A back coat, a metal thin film and a top coat are applied to an outer surface of a base member of a visor cover of a vehicle door mirror device, and in particular the metal thin film is formed by vapor deposition. The film thickness of the metal thin film can accordingly be made thinner than a case of when forming a metal film by plating, and the thickness of the metal thin film is easily managed. Accordingly, unwanted deformation of the visor cover when forming the metal thin film to the outer surface of the visor cover is not occurred, or deformation occurring in the visor cover can be suppressed.

### CROSS-REFERENCE TO RELATED APPLICATION

This application claims priority under 35 USC 119 from Japanese Patent Application No. 2012-133081 filed Jun. 12, 2012, the disclosure of which is incorporated by reference herein.

### BACKGROUND OF THE INVENTION

1. Field of the Invention

The present invention relates to a vehicle outer mirror device such as a door mirror or a fender mirror that is installed at the outside of a vehicle.

2. Related Art

Japanese Patent Application Laid-Open (JP-A) No. 2011-51435 (Patent Document 1) discloses a vehicle door mirror device that is an aspect of a vehicle outer mirror device. In the vehicle door mirror device, a mirror main body (mirror) and a visor cover (referred to as the “housing cover” in Patent Document 1) are attached to a stay (referred to as the “mirror base” in Patent Document 1) that is attached to the body of the vehicle.

The outer surface of the visor cover is colored variously according to for example the vehicle model. Plating processing such as chrome plating is performed on the visor cover in a case in which the outer surface of the visor cover is configured in a metallic color with a metallic luster.

In a case of forming a metal film to the visor cover by such plating processing, the thickness of the plating is difficult to manage (control), particularly in mass production, further, the visor cover deforms after plating processing. Since such plating is performed not only on the outer surface but also on an inner surface, the visor cover hardens as a whole. It accordingly becomes difficult to assemble other components such as a visor rim and a lens to the visor cover that has deformed as a result of plating processing as described above.

### SUMMARY OF THE INVENTION

In consideration of the above circumstances, the present invention is to obtain a vehicle outer door mirror device configured including a visor part formed with a metal thin film which has a metallic luster and whose film thickness is easily managed in which unwanted deformation and hardening is not readily occurred.

A vehicle outer mirror device according to a first aspect of the present invention includes: a mirror that is directly or indirectly supported by a stay attached to a vehicle body; and a visor that is formed by a plurality of visor parts being assembled and that is directly or indirectly supported by the stay, the minor being disposed inside the visor at an opening end side of the visor, and a metal thin film being formed by vapor deposition on an outer surface of at least one of the visor parts.

According to the vehicle outer mirror device of the first aspect of the present invention, the minor that is directly or indirectly supported by the stay is attached to the vehicle body via the stay. The visor formed by assembling of the plural visor parts is directly or indirectly supported by the stay, with the mirror disposed inside the visor at the opening end side.

The metal thin film is formed by vapor deposition to the outer surface of at least one of the visor parts configuring the visor. The external appearance of the visor accordingly takes on a metallic color, improving the appearance. The metal thin film of the outer surface of the visor part is formed by vapor deposition, as mentioned above. The film thickness can accordingly be made thinner than when a metal thin film is formed to the surface of the visor part by plating, and the thickness is easily managed.

Unwanted deformation accordingly is not occurred in the visor part (or deformation occurring in the visor part can be suppressed) during forming of the metal thin film to the outer surface of the visor part. Moreover, the thickness of the metal thin film can be made thinner than a case of plating, so the visor part does not harden to an excessive degree even when formed with the metal thin film. Assembly to other components, for example to other visor parts can accordingly be performed easily.

Note that there is no limitation to the aspect of the vehicle outer mirror device according to the present invention as long as it is a mirror device provided at the outside of a vehicle compartment. Accordingly, the present invention may be applied to what is referred to as a “vehicle door mirror device”, may be applied to what is referred to as a “vehicle fender mirror device”, or may be applied to what is referred to as a “vehicle side under-mirror device”.

A vehicle outer mirror device according to a second aspect of the present invention is the first aspect of the present invention further including: a back coat that is applied to the outer surface of the at least one of the visor parts so as to be interposed between the at least one of the visor parts and the metal thin film; and a top coat that is transparent and that is applied to the opposite side of the metal thin film from the back coat.

According to the vehicle outer mirror device of the second aspect of the present invention, the back coat is applied onto the visor part outer surface, and the metal thin film is formed on the back coat by vapor deposition. The transparent top coat is moreover applied onto the metal thin film. The three layers of film of the back coat, the metal thin film and the top coat are accordingly formed to the at least one of the visor parts of the vehicle outer mirror device of the present invention.

Note that when applying a coating film by a general coating, that is not a metallic color, to the visor part, a base coat of the desired color is applied to the outer surface of the visor part, and a transparent top coat is formed onto the surface of the base coat. In the present invention, as well as enabling the film thickness of the metal thin film to be made thinner as described above, the thickness is easily managed.

The sum of the film thickness of the back coat and the film thickness of the metal thin film can accordingly be set to be substantially equal to the film thickness of the base coat of the coating film described above. Accordingly, the same shape can be used for a visor with a metallic colored outer surface formed with the metal thin film by vapor deposition, and for a visor whose outer surface is given a color that is not a metallic color by coating, enabling a common mold to be used to mold the respective visors.

Note that the second aspect of the present invention may also be provided with other configuration elements as long as configuration includes the back coat, the metal thin film, and the top coat. For example, a film shaped middle coat may be interposed between the metal thin film and the top coat in consideration of for example the vehicle color, or the durability of components.

A vehicle outer mirror device according to a third aspect of the present invention is either the first aspect or the second aspect of the present invention, wherein the metal thin film is configured to include at least one of indium or tin.

According to the vehicle outer mirror device of the third aspect of the present invention, the metal thin film formed to the outer surface of at least one of the visor parts is configured includes at least one of indium (In) or tin (Sn). The metal thin film applied on the outer surface of the visor part accordingly takes on a metallic luster, improving the external appearance.

Note that in the present invention, there is no limitation to the metal thin film as long as the metal thin film includes at least one of indium (In) or tin (Sn), as described above. The metal thin film can accordingly be configured from indium, or may can be configured from tin. Configuration can also be made with an indium alloy, or with a tin alloy.

A vehicle outer minor device according to a fourth aspect of the present invention is the third aspect of the present invention, further including an antenna that is provided inside the visor and that receives an electromagnetic wave.

In the vehicle outer mirror device of the fourth aspect of the present invention, the antenna that receives an electromagnetic wave (radio wave) is provided inside the visor. The antenna can accordingly receive the electromagnetic wave that is output from externally to the visor. Due thereto, a transmitter is provided inside a tire and outputting electromagnetic waves including such as tire air pressure information, with the antenna inside the visor receiving the electromagnetic waves, thereby enabling the air pressure of the tire to be monitored from inside the vehicle compartment.

The metal thin film is formed on the visor part configuring the visor. However, forming the metal thin film by vapor deposition gives the metal thin film what is referred to as an “island structure”, wherein microscopic gaps are formed within the metal thin film, thereby enabling the electromagnetic waves to pass through these gaps. The antenna can accordingly receive electromagnetic waves that have been output from outside of the visor even when the antenna is provided inside the visor.

In the vehicle outer mirror device of the second to fourth aspects of the present invention, it is possible that plural regions where the metal thin film is formed are formed on the back coat, and gaps are formed between the regions.

As explained above, in the vehicle outer mirror device of the present invention a vehicle outer mirror device can be obtained configured including a visor part formed with a metal thin film which has a metallic luster and whose film thickness is easily managed in which unwanted deformation and hardening is not readily occurred.

### BRIEF DESCRIPTION OF THE DRAWINGS

Embodiments of the invention will be described in detail with reference to the following figures, wherein:

FIG. 1 is a cross-section schematically illustrating the structure of a back coat, a metal thin film and a top coat applied to a visor part of a vehicle outer mirror device according to an exemplary embodiment of the present invention;

FIG. 2 is a perspective view illustrating a vehicle outer mirror device according to an exemplary embodiment of the present invention, as viewed from a front face side;

FIG. 3 is a perspective view illustrating a configuration inside a visor of a vehicle outer mirror device according to an exemplary embodiment of the present invention, as viewed from a front face side; and

FIG. 4 is a back face view illustrating a configuration inside a visor of a vehicle outer mirror device according to an exemplary embodiment of the present invention.

### DETAILED DESCRIPTION OF THE INVENTION

### Configuration of the Present Exemplary Embodiment

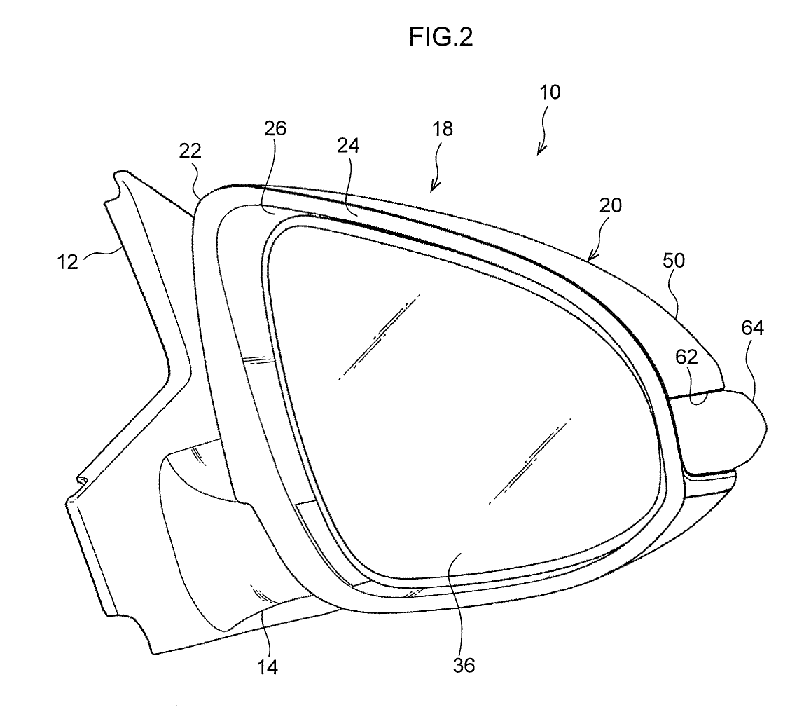

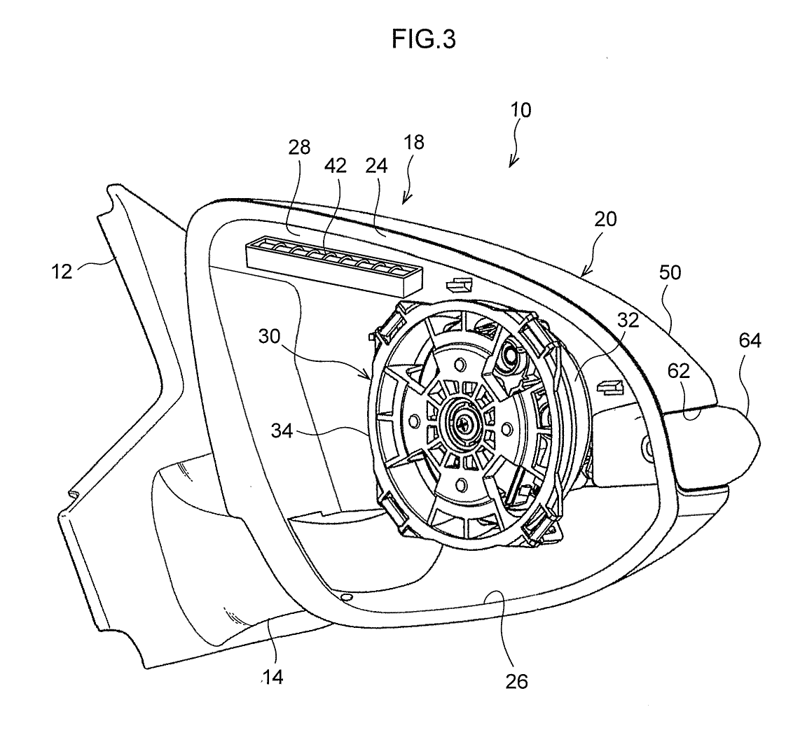

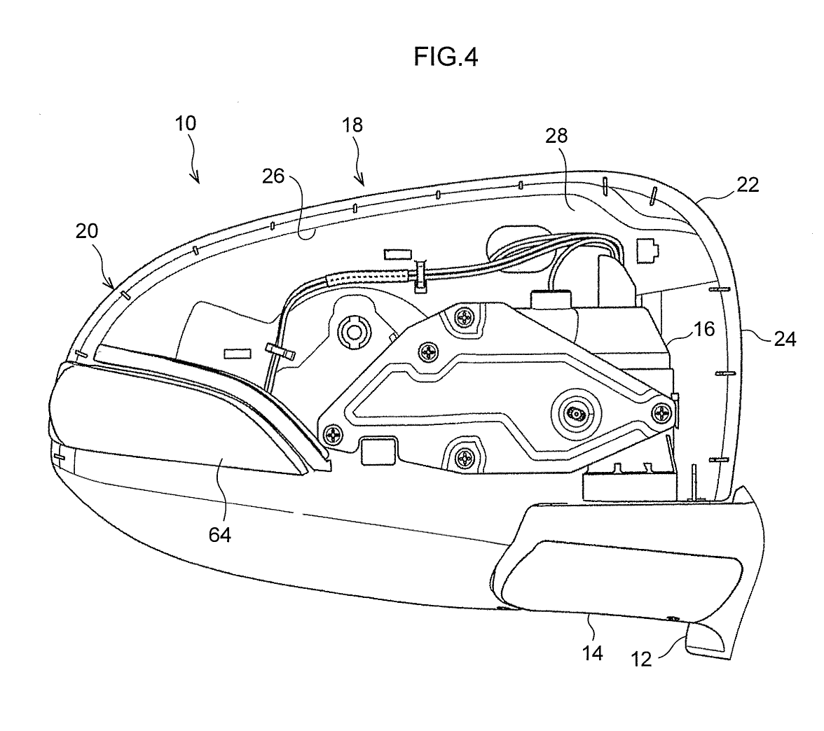

FIG. 2 is a perspective view illustrating a schematic overall configuration of a vehicle door mirror device 10 serving as a vehicle outer mirror device according to an exemplary embodiment of the present invention, as viewed from the diagonal right hand rear of the vehicle. FIG. 3 is a perspective view illustrating main portions of the vehicle door mirror device 10 as viewed from the diagonal right hand rear of the vehicle. FIG. 4 is a back face view of main portions of the vehicle door mirror device 10 as viewed from the vehicle front side.

The vehicle door mirror device 10 is externally provided at an up-down direction intermediate portion of a vehicle front side end portion of a vehicle door (not shown in the drawings). As shown in each of FIG. 2 to FIG. 4, the vehicle door minor device 10 is equipped with a stay 12 serving as a support member. The vehicle door mirror device 10 is supported on the door (vehicle body side) by attaching the stay 12 to the vehicle door. The stay 12 is provided with a block shaped support portion 14. The support portion 14 is formed so as to project out towards the vehicle width direction outside from a portion of the stay 12 that is supported on the door. The vehicle width direction outside portion (projection end portion) of the support portion 14 is formed in a substantially semi-circular column shape.

In the stay 12, a housing device 16 is provided, shown in FIG. 4, and a main body portion 18 is attached to the housing device 16. The housing device 16 is supported on the support portion 14 of the stay 12. The housing device 16 is capable of rotating with respect to the stay 12. The main body portion 18 is rotated with respect to the stay 12, and therefore with respect to the vehicle body, by rotating the housing device 16.

A visor body 22 that is one of visor parts configuring a visor 20 is attached to the housing device 16. The visor body 22 is equipped with a frame shaped rim portion 24, and a peripheral wall 26 is formed continuously from the rim portion 24. A bottom wall 28 is formed on the opposite side of the peripheral wall 26 to the rim portion 24, configuring the overall visor body 22 as a bottomed tube shape open towards the rim portion 24 side. The bottom wall 28 of the visor body 22 is attached to the housing device 16.

As shown in FIG. 3, a mirror face adjustment device 30 is provided inside the visor body 22. The mirror face adjustment device 30 is provided with a fix portion 32, with this fix portion 32 fixed to the bottom wall 28 of the visor body 22. A tilting body 34 is supported on the fix portion 32 at further towards the visor body 22 opening side than the fix portion 32. The tilting body 34 can be electrically or manually tilted with respect to the fix portion 32. A mirror 36, shown in FIG. 2, is mounted on the opposite side of the tilting body 34 to the fix portion 32. The mirror 36 is disposed inside the visor body 22 in a state in which a mirror face (reflective face) of the mirror 36 faces towards the visor body 22 opening side. By tilting the tilting body 34 of the mirror face adjustment device 30 with respect to the fix portion 32, the mirror 36 tilts integrally with the tilting body 34, thereby adjusting the angle of the reflective face of the mirror 36.

As shown in FIG. 3, an antenna 42 is also provided inside the visor body 22. The antenna 42 is equipped with a case 44 that is formed from a synthetic resin, and an antenna body, formed for example by forming a metal wire member into a coil shape, is housed inside the case 44. The antenna 42 is for example configured as an air pressure monitoring device that monitors the air pressure of the vehicle tires. The air pressure monitoring device includes pressure sensor(s) attached to tire wheel(s), and the pressure sensor outputs electromagnetic waves (radio waves) that include tire air pressure data. The electromagnetic waves output from the pressure sensor are received by the antenna body inside the case 44. The antenna body is connected to a monitor provided inside the vehicle compartment through a cable and through a controller provided in the vehicle, such that for example tire air pressure information is displayed on a monitor.

As shown in each of FIG. 2 to FIG. 4, a visor cover 50 that is one of the visor parts is mounted to the visor body 22 from the opposite side of the bottom wall 28 of the visor body 22 to the rim portion 24. The visor cover 50 is configured as a bottomed shape opening towards the rim portion 24 side of the visor body 22. The shape of the opening is configured to be the same as the outer peripheral shape of the rim portion 24, or to be a shape similar figure to but slightly smaller than the outer peripheral shape of the rim portion 24. Each of the components further to the bottom wall 28 side than the mirror 36, and in particular each of the components provided on the opposite side of the bottom wall 28 to the rim portion 24, are covered by the visor cover 50 by mounting the visor cover 50 to the visor body 22 as described above.

A cut-away (notch) portion 62 is formed in the visor cover 50. The cut-away portion 62 opens on the opening edge of the visor cover 50. A lens 64 is attached to the visor body 22 corresponding to the cut-away portion 62. When the visor cover 50 is mounted to the visor body 22, the lens 64 that serves as one of the visor parts enters the cut-away portion 62, with the lens 64 exposed to the outside of the visor cover 50. The lens 64 configures a turn signal lamp. A lamp of the turn signal lamp provided to the visor body 22 flashes (flickes) when an occupant in the vehicle compartment operates a turn signal switch, and light from the lamp is transmitted through the lens 64 such that it is visible from the outside.

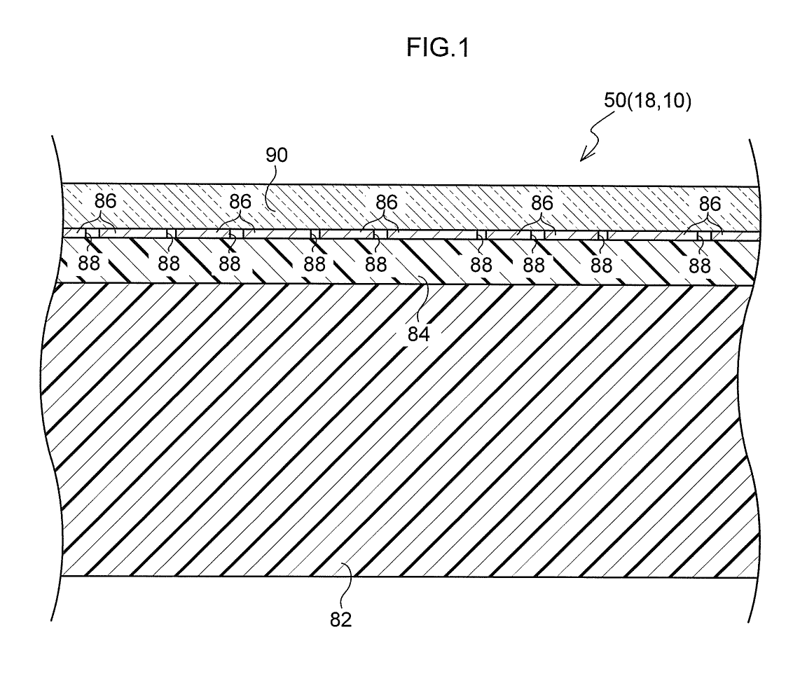

FIG. 1 schematically illustrates a cross-section structure of the visor cover 50. As shown in FIG. 1, the visor cover 50 is provided with a base member 82 that configures a main body portion. The base member 82 is formed by molding a synthetic resin, and forms the shape of the visor cover 50. At an outer surface of the base member 82 (a face of the base member 82 that is directed towards the outside of the visor cover 50), a back coat 84 is formed. The back coat 84 is formed by coating to the outer surface of the base member 82 and is configured with a thickness of 40 μm or below.

A metal thin film 86 is formed on the opposite side of the back coat 84 to the base member 82. The metal thin film 86 is formed by performing vapor deposition of indium (In), tin (Sn) or alloy thereof to the surface of the back coat 84, and is set at a thickness of 1 μm or below. The outer surface of the visor cover 50 accordingly takes on a metallic color with a metallic luster by forming the metal thin film 86 using vapor deposition.

Moreover, due to forming the metal thin film 86 using vapor deposition, the metal thin film 86 takes on what is referred to as an “island structure”, numerous regions where the metal thin films 86 are formed (namely regions where metal has been vapor deposited) are formed on the back coat 84, with tiny gaps 88 formed between each of the regions where the metal thin films 86 are formed. Moreover, due to the metal thin film 86 being formed by vapor deposition, it is difficult for sublimated metal to get to the inside the visor cover 50. The metal thin film 86 is therefore basically not formed on the inside of the visor cover 50.

A top coat 90 which is transparent is further applied on the metal thin film 86 at the side opposite to the back coat 84 side. The top coat 90 is coated on with a thickness of 50 μm or below. The metal thin film 86 is accordingly covered by the top coat 90. Damage to the metal thin film 86 is therefore prevented or suppressed.

Note that the thickness of the back coat 84 is substantially equal to the thickness of a base coat at a case of applying an ordinary color coating to a visor cover 50, in which the metal thin film 86 is not formed. The top coat 90 also has a thickness substantially equal to that of a top coat at a case of applying an ordinary color coating to the visor cover 50.

### Operation and Advantageous Effects of the Present Exemplary Embodiment

In the vehicle door minor device 10 configured as described above, the metal thin film 86 is formed by vapor deposition on the outer surface of the visor cover 50 that configures the visor 20. The external appearance of the visor 20 accordingly takes on a metallic color, improving the appearance. The metal thin film 86 on the outer surface of the visor cover 50 is formed by using vapor deposition as described above. The film thickness of the metal thin film 86 can accordingly be made thinner than when a metal film is formed on the surface of the visor cover 50 by plating, and the film thickness is easily managed (controlled).

Unwanted deformation accordingly does not occur in the visor cover 50 (or deformation of the visor cover 50 that occurs can be suppressed) when forming the metal thin film 86 on the outer surface of the visor cover 50. Moreover, as described above, the thickness of the metal thin film 86 can be made thinner than when using plating, with the visor cover 50 not hardening to an extreme degree even when the metal thin film 86 is formed, with the structure of the metal thin film 86 being the island structure described above. Assembly of the visor cover 50 to the visor body 22 can accordingly be performed easily.

In particular, in the present exemplary embodiment, the cut-away portion 62 into which the lens 64 enters is formed to the visor cover 50, with the cut-away portion 62 opening on the opening edge of the visor cover 50. Accordingly, in the conventionally visor cover, there is possibility that the visor cover 50 at one side of the cut-away portion 62 to deform with respect to the visor cover 50 at the other side of the cut-away portion 62 and is hardened, so assembly of the visor cover 50 to the visor body 22 would become difficult, and in some cases assembly of the visor cover 50 to the visor body 22 would become impossible, such that the visor cover 50 ends up as a defective part.

However in the present exemplary embodiment, deformation of the visor cover 50 such as that described above is not readily occurred. The metal thin film 86 has an island structure, and moreover does not harden to an extreme degree, and so even supposing slight deformation were to occur in the visor cover 50, it would still be possible to assemble the visor cover 50 to the visor body 22. Accordingly, defects do not readily occur in the visor cover 50, improving manufacturing yield, enabling low costs as a result.

The metal thin film 86 is moreover formed onto the back coat 84 that has been applied to the base member 82 of the visor cover 50. The transparent top coat 90 is further applied onto the metal thin film 86. In the present exemplary embodiment, three film layers are accordingly formed on the base member 82 of the visor cover 50, namely the back coat 84, the metal thin film 86, and the top coat 90.

As described above, the thickness of the back coat 84 is substantially equal to the thickness of a base coat of a desired color, that is applied to the outer surface of the base member 82 of the visor cover 50, in a case of applying a coating film of non-metallic color by an ordinary coating (painting) to the visor cover 50. Moreover, the thickness of the top coat 90 applied on the metal thin film 86 is substantially equal to the thickness of a top coat in a case of applying a coating film of non-metallic color by an ordinary coating to the visor cover 50. The thickness of the metal thin film 86 is sufficiently small in comparison to the thickness of the back coat 84 and the thickness of the top coat 90.

The total thickness of the three film layers of the back coat 84, the metal thin film 86 and the top coat 90 can accordingly be set substantially equal to the overall thickness of the base coat and top coat in a case of applying a coating film of non-metallic color by an ordinary coating to the visor cover 50. Accordingly, the same shapes can be employed both for a visor cover 50 with a metallic colored outer surface and for a visor cover 50 of which the outer surface is given a color that is not a metallic color by coating, enabling a common mold to be used to mold the respective visor covers 50.

In the present exemplary embodiment, electromagnetic waves output externally to the visor 20 are received by the antenna 42 that is provided inside the visor body 22. Although the metal thin film 86 is formed to the visor cover 50, the metal thin film 86 has an island structure as described above, with the very small (microscopic) gaps 88 formed in the metal thin film 86 (between the regions where the metal thin films 86 are formed). Electromagnetic waves can accordingly pass through the gaps 88 in the metal thin film 86 even with the metal thin film 86 formed on the visor cover 50. Electromagnetic waves output from outside of the visor 20 can therefore be received by the antenna 42 even when the antenna 42 is provided inside the visor body 22.

Note that in the present exemplary embodiment, the material in vapor deposition to configure the metal thin film 86 is indium (In) or tin (Sn), or an alloy thereof, however there is no limitation to indium (In) or tin (Sn) or an alloy thereof as the material in vapor deposition to configure the metal thin film 86. Other examples of metals and alloys that may be used include metals and alloys of for example aluminum (Al), chromium (Cr), zinc (Zn), silver (Ag) and nickel (Ni), and oxides or fluorides of for example silicon (Si), titanium (Ti) and magnesium (Mg) may also be used.

Although no particularly detailed explanation has been given regarding the method of forming the metal thin film 86, any method general referred to as “vacuum vapor deposition” is applied, although other than vacuum vapor deposition a physical vapor deposition method or a chemical vapor deposition method may also be applied.

Moreover, in the present exemplary embodiment, configuration is made wherein the back coat 84, the metal thin film 86 and the top coat 90 are formed on the outer surface of the base member 82 of the visor cover 50. However, obviously configurations other than that of the back coat 84, the metal thin film 86 and the top coat 90 are also possible. For example, a film shaped middle coat may be formed between the metal thin film 86 and the top coat 90 in consideration of for example the vehicle color, or the durability of components.

Moreover, the vehicle outer mirror device according to the present exemplary embodiment of the present invention is applied to the vehicle door mirror device 10, however the present invention may also be applied to other vehicle outer mirror devices such as a vehicle fender mirror device or a vehicle side under-mirror device.

What is claimed is:

1. A vehicle outer mirror device comprising:
a mirror that is directly or indirectly supported by a stay attached to a vehicle body; and
a visor that is formed by a plurality of visor parts being assembled and that is directly or indirectly supported by the stay, the mirror being disposed inside the visor at an opening end side of the visor, and a metal thin film being formed by vapor deposition on an outer surface of at least one of the visor parts.

2. The vehicle outer mirror device of claim 1, further comprising:
a back coat that is applied to the outer surface of the at least one of the visor parts so as to be interposed between the at least one of the visor parts and the metal thin film; and
a top coat that is transparent and that is applied to the opposite side of the metal thin film from the back coat.

3. The vehicle outer mirror device of claim 1, wherein the metal thin film is configured to include at least one of indium or tin.

4. The vehicle outer mirror device of claim 2, wherein the metal thin film is configured to include at least one of indium or tin.

5. The vehicle outer mirror device of claim 3, further comprising an antenna that is provided inside the visor and that receives an electromagnetic wave.

6. The vehicle outer mirror device of claim 4, further comprising an antenna that is provided inside the visor and that receives an electromagnetic wave.

7. The vehicle outer mirror device of claim 2, wherein plural regions where the metal thin film is formed are formed on the back coat, and gaps are formed between the regions.

8. The vehicle outer mirror device of claim 5, wherein plural regions where the metal thin film is formed are formed on the back coat, and gaps are formed between the regions.
